(19) United States
(12) Patent Application Publication
(10) Pub. No.: US 2016/0089217 A1
(43) Pub. Date: Mar. 31, 2016

(54) NON-CYLINDRICAL DENTAL IMPLANT SYSTEM

(71) Applicants: Trustees of Boston University, Boston, MA (US); Fraunhofer USA, Inc., Plymouth, MI (US)

(72) Inventors: Robert Gyurko, Reading, MA (US); Serge Dibart, Waltham, MA (US); Andre Sharon, Newton, MA (US); Alexis Sauer-Budge, Lincoln, MA (US); Holger Wirz, Medford, MA (US)

(21) Appl. No.: 14/959,319

(22) Filed: Dec. 4, 2015

Related U.S. Application Data
(63) Continuation of application No. PCT/US2014/041321, filed on Jun. 6, 2014.
(60) Provisional application No. 61/971,177, filed on Mar. 27, 2014.
(60) Provisional application No. 61/831,799, filed on Jun. 6, 2013.

(51) Int. Cl. A61C 8/00

(52) U.S. Cl. CPC A61C 8/0037; A61C 8/0089; A61C 2008/0046

(57) ABSTRACT

A dental implant includes an upper connector portion and lower implantation portion, the connector portion receiving a dental crown or similar prosthesis, the implantation portion having rectangular cross section and linear vertical profile with machine taper. An outer surface of the implantation portion provides frictional fit with a correspondingly shaped surrounding bone surface. A bone removal tool includes a hand-held actuator generating high-frequency, small-amplitude vibration, and an attached metal tool tip having elongated head portion and curved neck portion. The head portion has rectangular cross section and linear taper, and an outer surface of the head portion has a saw-toothed grinding pattern for removing bone. The neck portion is dimensioned and configured to establish mechanical resonance of the tool tip including axial reciprocating action of the head portion in response to the actuator vibration.

### BACKGROUND

The present invention relates to the field of dental implants and other applications involving bone removal.

### SUMMARY

Current dental implants are cylindrical in shape and placed using rotary dental burs. For patients with long-lost teeth and narrow alveolar ridge the cylindrical implant shape does not match the shape of the available bone. The mechanical properties of titanium and its alloys places limits on how small a cylindrical implant can be while withstanding biting forces.

Bone grafting with cadaver bone is a common solution to enlarge the jawbone at the desired implant site. While generally successful, bone grafting has several drawbacks:
Increased treatment time (average 6 months) until grafted bone heals
Additional cost of bone graft
Patient's reluctance towards cadaver bone
Extra procedure exposes patient to additional surgical risks

Mini-implants offer another solution; however, with decreasing diameter, implant survival and load-carrying capacity decreases, thus mini-implants are currently limited to providing adjunctive support for removable dentures and anchoring orthodontic appliances.

In one aspect of the present disclosure, a dental implant is described that has a unitary body of a high-strength surgical metal suitable for implantation in a live jaw bone. The body includes an intra-oral connector portion and an elongated intra-bony implantation portion. The connector portion is configured to extend above a ridge of the jaw bone at an implantation site and receive a separate dental crown to form a dental prosthesis. The implantation portion has a substantially rectangular cross section and a linear vertical profile with a machine taper of less than ten degrees to a lower end. An outer surface of the implantation portion has sufficient roughness to provide a frictional fit with a correspondingly shaped surrounding bone surface at the implantation site upon application of axial implantation force to the dental implant.

In another aspect of the present disclosure, a bone removal tool is described that includes a hand-held actuator operative to generate a high-frequency, small-amplitude mechanical vibration at an actuated end, and a metal tool tip at the actuated end of the hand-held actuator. The tool tip has a base portion, an elongated head portion and a curved neck portion. The base portion is rigidly attached to the actuated end to receive the small-amplitude mechanical vibration. The head portion has a substantially rectangular cross section and a linear taper to a distal end, and an outer surface of the head portion has a saw-toothed grinding pattern for removing bone. The curved neck portion is dimensioned and configured to establish a mechanical resonance of the tool tip, including an axial reciprocating action of the head portion relative to the base portion in response to the small-amplitude mechanical vibration of the hand-held actuator.

### BRIEF DESCRIPTION OF THE DRAWINGS

Objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a schematic cutaway mechanical diagram of a dental implant in bone;

FIGS. 2 and 3 are isometric perspective and elevation views of a dental implant;

FIGS. 4 and 5 are schematic mechanical diagrams depicting attachment of an abutment to a dental implant;

FIGS. 6 and 7 are isometric perspective and elevation views of a second dental implant;

FIG. 8 is a schematic cutaway mechanical diagram of the second dental implant in bone;

FIGS. 9-11 are side views of a burring tool tip, a roughing tool tip, and a widening tool tip respectively;

FIG. 12 is a perspective view of a head portion of the roughing tool tip;

FIG. 13 is a side view of the roughing tool tip;

FIG. 14 is a solid model view showing reciprocating movement of the roughing tool tip;

FIGS. 15 and 16 are side views of the head portion of the widening tool;

FIG. 17 is a schematic mechanical side view of a bone removal tool including a tool tip and actuator.

### DETAILED DESCRIPTION

The disclosure of U.S. provisional application 61/831,799 filed Jun. 6, 2013 is incorporated by reference herein in its entirety.

A dental implant system is disclosed. Among other advantages, the implant system may help eliminate the need for bone grafting for patients having narrow residual jawbone, thus making implant treatment faster, less invasive and less expensive.

The system is based on the notion that the implant should match the shape of the available bone, thus eliminating the need for bone grafting. The system includes a miniature bone saw, or “piezotome”, which vibrates at ultrasonic frequencies and sub-millimeter amplitudes. The piezotome is capable of creating various shapes of non-round bone cuts, as opposed to currently available implant drills that are all rotating instruments. Thus for narrow bone ridges narrow bone cuts can be made and flat implants may be precisely fitted. Other shapes may be employed as the clinical needs dictate.

The disclosed implant system includes the implants and a method for implanting, using a piezotome with specially designed tool tips. In particular, an implant having a generally rectangular cross section is disclosed, having an aspect ratio on the order of 2.5 for example. The relatively flat cross section addresses the need of patients with narrow residual jawbone, without compromising implant stability and longevity. The implant is designed with a rectangular cross-section that can sustain the normal grinding forces. A secondary design also includes a wing that can serve to increase the stability of the implant in the bone.

For the installation of the implant, first a small cylindrical bur is used to drill a pilot hole in the jaw bone. This osteotomy is enlarged with a roughing tool tip that widens along the long axis of the bone. A widening tool tip is then used to widen the osteotomy. The shape of the osteotomy is matched to that of the implant, which can then be implanted in the bone. Only an upper connector portion of the implant protrudes into the mouth, providing connection to the artificial teeth. A variety of other shapes may be designed to enhance initial stability and integration. The osteotomy and the implant are designed to provide primary stability by 1) matching the shape of the osteotomy to the implant, 2) including a machine taper into the design of the implant so that the implant is self-locking into the osteotomy, 3) leaving the osteotomy edges somewhat rough to increase the friction on the sides of the implant once implanted, and 4) designing the geometry of the implant to be able to withstand the expected forces in the mouth.

The tool tips are designed to maximize the sawing action of the tool for rapid removal of bone and to minimize the required number of tool changes. The tool tips are optimized so that at a predetermined operating frequency (e.g., ˜30 kHz) the major mode of tool motion exhibits a sawing action.

In the present description items are described using directional terms such as “upper”, “lower”, etc. These are used for convenience and are to be understood as literally applicable only when an item is in a canonical upright orientation. In the case of an implant, of course, it is in the opposite orientation when placed in an upper jawbone.

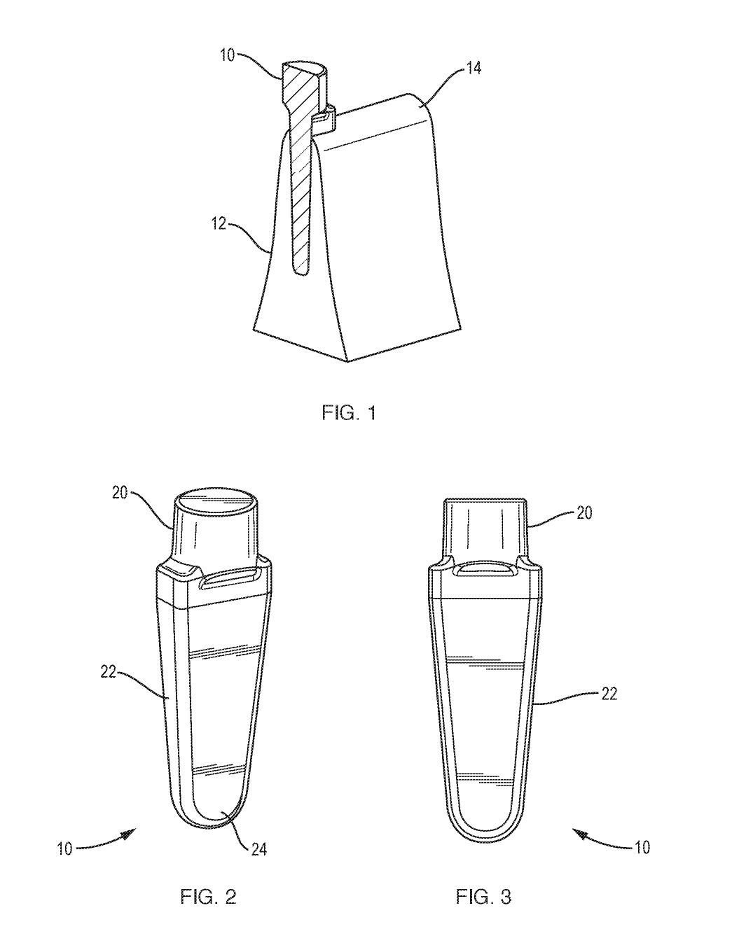

FIG. 1 illustrates the placement of a dental implant 10 in bone 12 such as a jaw bone. As shown, a lower portion of the dental implant 10 resides in the bone 12 while a smaller upper portion protrudes slightly above a ridge 14 for affixing of a dental prosthetic such as a crown. One feature of the disclosed dental implant is a flattened rectangular cross section, described more below, in contrast to conventional implants having a circular cross section. This shape may provide a better fit in jaw bones having relatively narrow ridges 14 without sacrificing performance or requiring special additional procedures such as bone grafting.

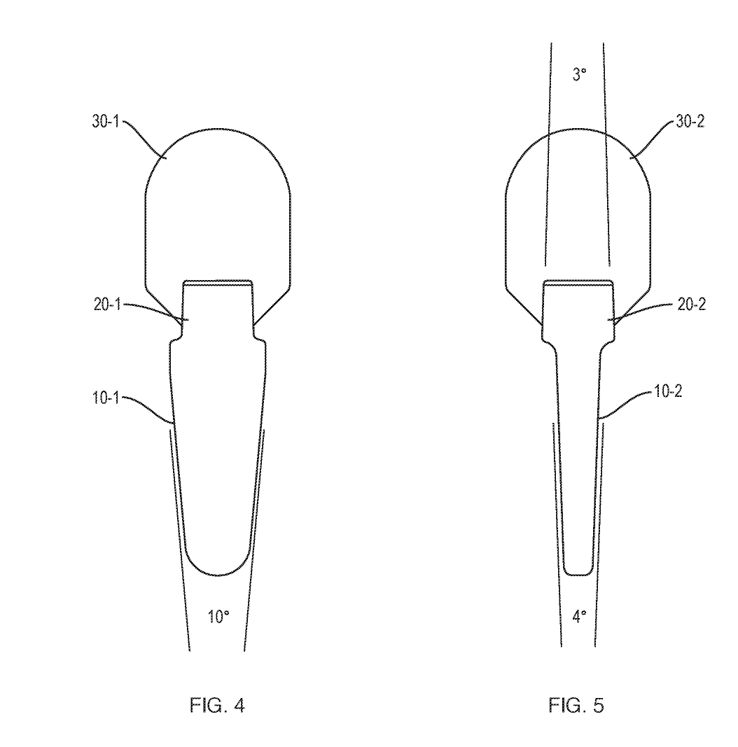

FIGS. 2 and 3 show the complete implant 10 in more detail. It is of one-piece or unitary design, made of a titanium alloy or similar strong, bio-compatible metal material. It has an upper connector portion 20 to which a dental prosthetic (not shown) is attached, and a lower implantation portion 22 that is implanted into the bone 12. As best seen in FIG. 2, the implantation portion 22 has a generally rectangular cross section with slightly rounded edges, as well as a slight taper toward a distal end 24. The cross section aspect ratio is about 2.2 (i.e., the long dimension is 2.2 times the short dimension). As best seen in FIGS. 4 and 5, described below, in the illustrated embodiment the taper of the implantation portion 22, which is known as a “machine taper” or colloquially a “Morse taper”, is 10 degrees (included angle) for the narrow sides and 4 degrees (included angle) for the flat sides. The taper of the connector portion 20 is 3 degrees (included angle). The taper angles are selected to enable the respective portion 20, 22 to form an acceptable interference fit with a surrounding surface upon installation (a bone surface surrounding the implantation portion 22 and a machined surface of a prosthetic surrounding the connector portion 20).

Overall, the implant 10 is designed to fit into a narrow bone ridge such as that of a human jaw bone. Its geometry is optimized to maximize the forces it can withstand while still fitting in a narrow ridge. It is also designed with a machine taper for a self-locking interference fit providing high “primary” stability, i.e., mechanical stability apart from any additional stabilizing features such as pins or screws etc. that might also be used.

FIGS. 4 and 5 partially illustrate attachment of a prosthesis (two side views). In both cases, an intermediate component referred to as an “abutment” 30 is secured to the connector portion 20 of the implant 10. A separate dental crown or bridge (not shown) is attached to the abutment 30 using known techniques. The abutment 30 will typically have circular or other cross section and be shaped as needed to mate with the crown or bridge. In the arrangement of FIG. 4, the abutment 30 is secured to the connector portion 20-1 via a frictional fit of like-tapered surfaces.

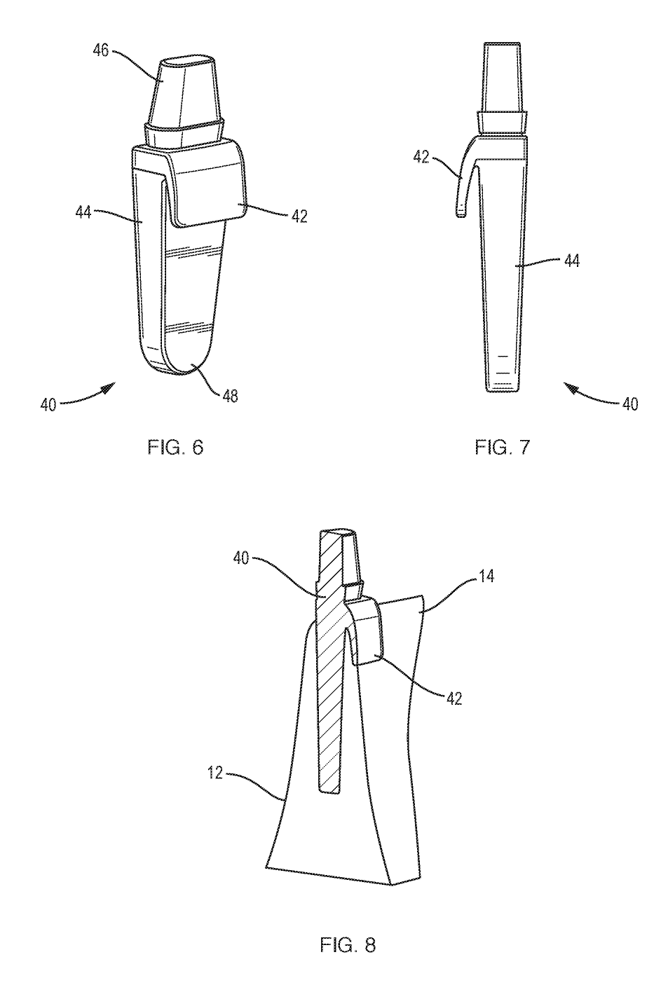

FIGS. 6-8 illustrate a second embodiment of an implant 40 generally similar to the first implant 10 but also including a stability-enhancing projection 42, referred to as a wing 42. The wing 42 extends slightly outwardly and down from the upper end of the implantation portion 44. As shown, the connector portion 46 and lower end 48 may be the same as in the first implant 10. The wing 42 enhances stability by adding a pinching force to the frictional fit. At the same time, it is placed toward the tongue and thus does not compromise the aesthetics of the implant.

One feature of the implants 20, 40 is a cross-sectional aspect ratio greater than 1, i.e., its length in the direction of the jawline is greater than its width across the jawline. Very generally, a larger implant will be more stable than a smaller one, and generally there is more bone to work with in the direction of the jawline than there may be in the direction across the jawline. This is especially the case for a regressed jaw bone. In one embodiment, the implant has cross-sectional dimensions of 2.1 mm×4.5 mm, which is an aspect ratio of 1:2.2. More generally, an aspect ratio in the range of 1:2 to 1:3 may be desirable, possibly higher in some cases.

The roughness of the surfaces of the implant may be similar to that for existing implants, about 2 micrometers micro feature size. Surface treatment may include sandblasting and acid etching to obtain the mildly roughened implant surface.

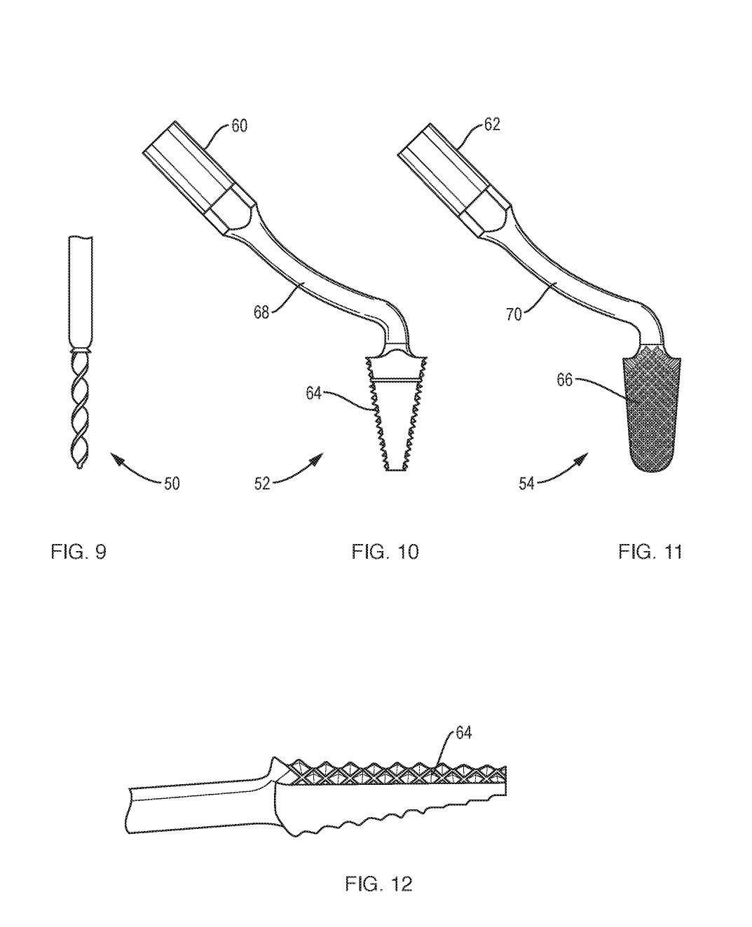

FIGS. 9-11 illustrate three tools used to create an opening in a jaw bone, referred to as an “osteotomy”, at an implantation site where an implant is to be placed. In order of use are a standard rotating dental bur 50 (FIG. 9), a specialized roughing tool 52 (FIG. 10), and a specialized widening tool 54 (FIG. 11). The dental bur 50 is used to make a small pilot hole at the implantation site, large enough to accommodate a tip-most portion of the roughing tool 52. The roughing tool 52 is then used to expand the pilot hole into a more rectangular-shaped opening elongated in the direction of the bone ridge 14. To this end the roughing tool 52 has rasp-like narrower surfaces (left and right in FIG. 10; shown in more detail in FIG. 12), and is smooth on the two broader surfaces (facing front and rear in FIG. 10). Finally the widening tool 54 is used to slightly widen the hole in the perpendicular direction, to a width matching that of the implant (e.g., implant 10). To this end the widening tool 54 has rasp like broader surfaces (facing front and rear in FIG. 11) and is smooth on the two narrower surfaces (left and right in FIG. 11). Once the osteotomy is formed in this manner, the implant can be driven into it by application of axial force, such as by a surgical hammer, creating a tight interference fit that retains the implant in the bone.

The roughing tool 52 and widening tool 54 are preferably implemented as tool “tips” that are attached to a separate handheld actuator (not shown) during use. These tools require a back-and-forth or reciprocating motion in use, and as described in more detail below such motion is achieved through a combination of a vibrational actuation and a resonant mechanical configuration that translates the vibrational actuation to the reciprocating motion. As shown, each tool has a respective base portion 60, 62, respective head portion 64, 66, and respective neck portion 68, 70. The base portions 60, 62 attach to the actuator in use, and the head portions 64, 66 apply back-and-forth grinding action to remove bone. The neck portions 68, 70 are dimensioned and configured to provide a longitudinal resonance response to vibration received from the actuator via the base portions 60, 62, thus creating the desired reciprocating motion of the head portions 64, 66. This resonance is described in more detail below.

Thus salient features of the roughing tool 52 include:
Saw tooth edges to rapidly widen pilot hole along the long axis of the bone
Tip fits into pilot hole
Shape and bends of tool rod are optimized to enhance sawing motion and displacement at operating frequency
Edges of osteotomy are left rough to increase the friction and thus primary stability of the implant

Salient features of the widening tool 54 include:
Similar design to roughing tool 52, but rasp-like grooves (similar to a file) are designed into the other faces to widen the osteotomy in the axis perpendicular to the long axis of the bone.

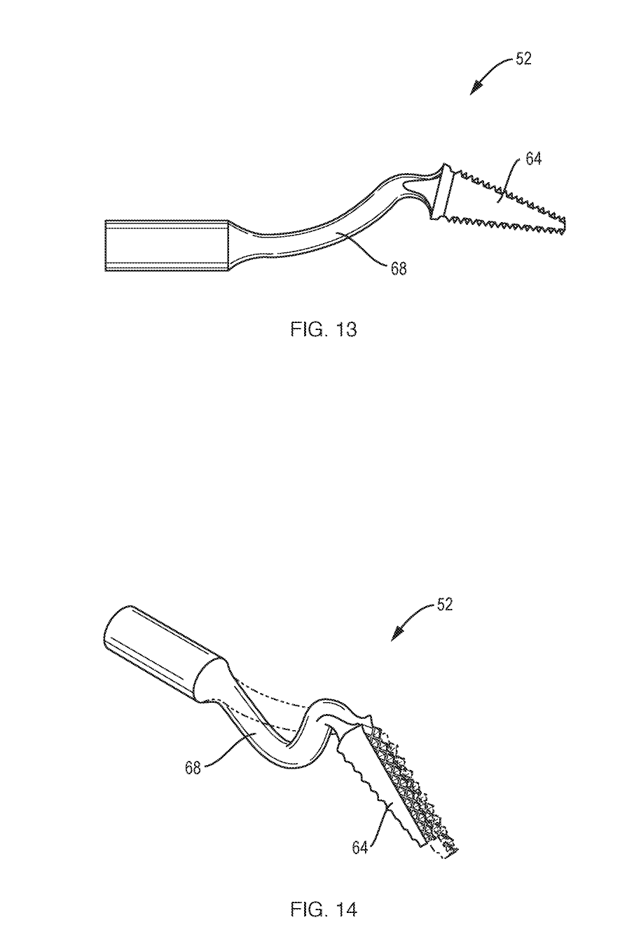

FIG. 13 shows the neck portion 68 of the roughing tool 52 as having one relatively long bend (upward in this figure) and a much shorter and sharper bend (downward in this figure) where the neck portion 68 meets the head portion 64. The longer bend provides the major resonance response to the vibrational excitement from the actuator, and this response has some dependence on the magnitude of the bend angle as illustrated in the table below:

| Angle[°] | Frequency [kHz] | Frequency [%] |
|---|---|---|
| 15 | 34.2 | 12.54% |
| 30 | 30.39 | 0.00% |
| 45 | 26.5 | −12.80% |
| 60 | 23.21 | −23.63% |
| 75 | 20.76 | −31.69% |

Taking 30° as a starting point, the resonance response has a resonance frequency of about 30 kHz. Varying this angle by 15° either direction (smaller or larger) changes the frequency by about 12.5% (higher and lower, respectively). Additional 15° increases bring corresponding additional decreases in the resonance frequency. It will be appreciated that a given implementation of a tool tip 52, 54 will be designed to have a resonant frequency substantially matching the vibration frequency of the actuator, to obtain maximum-amplitude sawing action most efficiently.

FIG. 14 illustrates the reciprocating or sawing action resulting from the mechanical resonance of the tool tip, in this case tool tip 52. The action is greatly exaggerated for illustration purposes. It can be seen that the neck portion 68 flexes between a relatively flatter position and a relatively more bent position, and the head portion 64 moves between a relatively more forward position and a relatively more rearward position. This is the reciprocating motion providing the grinding action via the teeth on the outer surface. In a real device of typical dimensions, the amplitude of the reciprocating motion may be on the order of 0.1 mm.

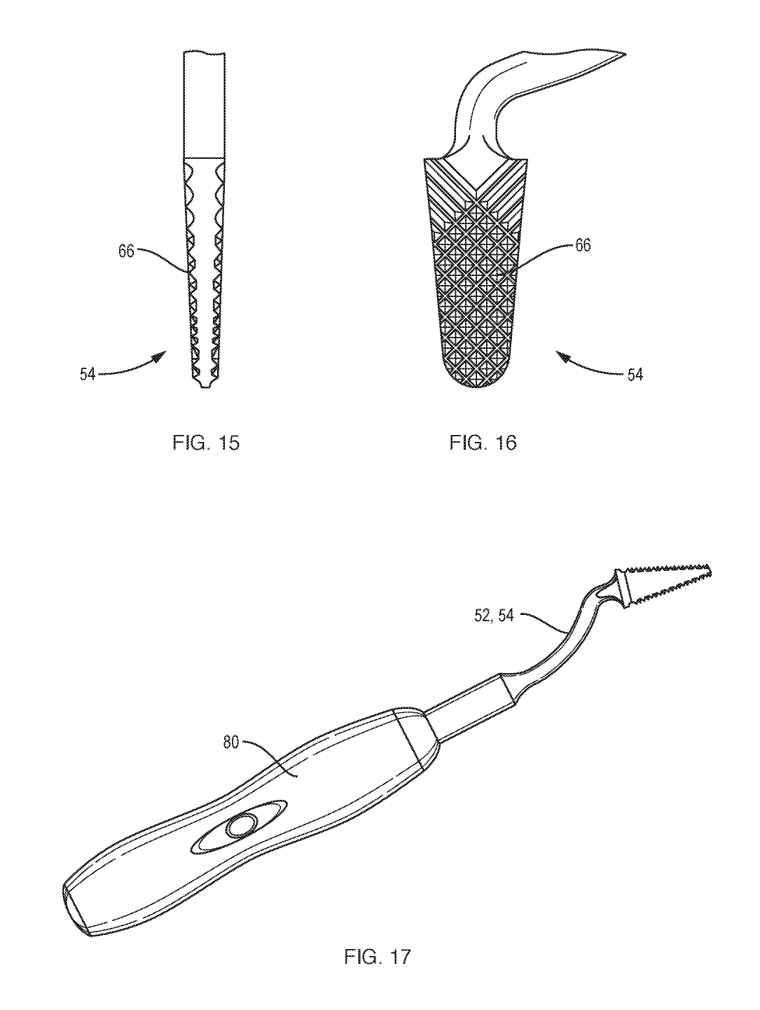

FIGS. 15-16 are views of the widening tool 54. This tool has design and functioning similar to those of the roughing tool 52, except that its teeth are located on the broader surfaces to provide a grinding action that will widen the osteotomy across the width of the bone ridge 14 (FIG. 1). It is preferable to use different tools for the two orthogonal directions for greater accuracy and reduced likelihood of adversely affecting one dimension of the osteotomy when working on the other dimension.

FIG. 17 depicts a bone removal tool using a tool tip 52, 54 as described above. The tool includes an elongated cylindrical actuator 80 to which the tool tip 52, 54 is attached at an actuated end. The tool tip 52, 54 may be attached using any of a variety of techniques, including frictional fit with a mating post or socket at the actuated end. The tool is of a size to be hand held. In one embodiment the actuator 80 may employ piezoelectric component(s) to obtain vibrational mechanical motion at the actuated end based on oscillatory electrical excitation provided by electrical circuitry (not shown) housed within the actuator 80. In other embodiments other electro-mechanical transducer technologies may be employed.

### Alternatives

In addition to piezo technology the bone cutting device (osteotome) can utilize other vibrating technologies.

The tool tips may be used in other procedures involving precision bone removal. Piezotomy may be used to increase bone density in other biological settings, erg healing of non-union fractures.

### Products/Services

Dental implants

Orthopedic appliances

Bone growth-stimulating devices

Bone wound healing devices

Ex vivo bone growing processes

Summary of key aspects of present disclosure:
1. A dental implant device and method of use to preclude the need for bone grafts in patients with long lost teeth and significant bone loss (e.g. only a residual bone ridge)
2. A non-cylindrical vibrating bone cutting device that is shaped to match the dimensions of a dental implant
3. The corresponding non-cylindrical dental implant with a Morse taper to enhance primary stability
4. The geometry of the implant to be able to sustain the forces encounter during chewing/use of teeth
5. The tools leave a rough surface that increases the friction between the osteotomy and the implant to increase primary stability
6. The design of the tool tip so that at operating frequency the major mode is in a sawing motion.
7. The ability of this bone cutting device to increase bone density
8. The implant can also be designed with a wing to further increase the primary stability of the implant. This wing can be placed on the inside of the mouth so as not to detract from the aesthetic of the implant.

While various embodiments of the invention have been particularly shown and described, it will be understood by those skilled in the art that various changes in form and details may be made therein without departing from the scope of the invention as defined by the appended claims.

What is claimed is:

1. A dental implant comprising a unitary body of a high-strength surgical metal suitable for implantation in a live jaw bone, the body including an upper connector portion and an elongated lower implantation portion, the connector portion being configured to extend above a ridge of the jaw bone at an implantation site and receive a separate dental prosthesis, the implantation portion having a substantially rectangular cross section and a linear vertical profile with a machine taper to a lower end, an outer surface of the implantation portion having sufficient roughness to provide a frictional fit with a correspondingly shaped surrounding bone surface at the implantation site upon application of axial implantation force to the dental implant.

2. A dental implant according to claim 1, wherein a cross-sectional aspect ratio of the implantation portion is in the range 1:2 to 1:3.

3. A dental implant according to claim 1, wherein the outer surface has micro features of 2 micrometers in size establishing the roughness for the frictional fit.

4. A dental implant according to claim 1, wherein the lower end of the implantation portion is rounded.

5. A dental implant according to claim 1, wherein the unitary body includes a flat wing portion extending downward from the an upper part of the implantation portion.

6. A dental implant according to claim 5, wherein the wing portion extends downward less than one-half the length of the implantation portion.

7. A dental implant according to claim 6, wherein the wing portion extends downward less than one-third the length of the implantation portion.

8. A dental implant according to claim 1, wherein the connector portion has a machine taper to a blunt upper end to form a frictional fit with an abutment portion of a dental prosthesis.

9. A bone removal tool, comprising:
a hand-held actuator operative to generate a high-frequency, small-amplitude mechanical vibration at an actuated end; and
a metal tool tip at the actuated end of the hand-held actuator, the tool tip having a base portion, an elongated head portion and a curved neck portion, the base portion being rigidly attached to the actuated end of the actuator to receive the small-amplitude mechanical vibration therefrom, the head portion having a substantially rectangular cross section and a linear taper to a distal end, an outer surface of the head portion having a saw-toothed grinding pattern for removing bone, the curved neck portion being dimensioned and configured to establish a predetermined mechanical resonance of the tool tip including an axial reciprocating action of the head portion relative to the base portion in response to the small-amplitude mechanical vibration of the hand-held actuator.

10. A bone removal tool according to claim 9, wherein the neck portion is curved in a plane in which a wide aspect of the head portion lies.

11. A bone removal tool according to claim 10, having smooth opposing wide surfaces and having rasp-like opposing narrow surfaces dimensioned and configured to widen an opening in bone in a direction lying in the plane.

12. A bone removal tool according to claim 10, having smooth opposing narrow surfaces and having rasp-like opposing wide surfaces dimensioned and configured to widen an opening in bone in a direction perpendicular to the plane.
